(19) United States
(12) Patent Application Publication
(10) Pub. No.: US 2024/0204235 A1
(43) Pub. Date: Jun. 20, 2024

(54) SECONDARY BATTERY

(71) Applicant: MURATA MANUFACTURING CO., LTD., Kyoto (JP)

(72) Inventor: Motohisa SUZUKI, Kyoto (JP)

(21) Appl. No.: 18/414,618

(22) Filed: Jan. 17, 2024

Related U.S. Application Data
(63) Continuation of application No. PCT/JP2022/030722, filed on Aug. 12, 2022.

(30) Foreign Application Priority Data
Aug. 18, 2021 (JP) 2021-133214

(51) Int. Cl. H01M 10/04; H01M 10/0525; H01M 50/109; H01M 50/153; H01M 50/545; H01M 50/559; H01M 50/586

(52) U.S. Cl. CPC H01M 10/0427; H01M 10/0431; H01M 10/0525; H01M 50/109; H01M 50/153; H01M 50/545; H01M 50/559; H01M 50/586

(57) ABSTRACT

A secondary battery includes an outer package member and a battery device. The outer package member has a columnar shape. The battery device is contained inside the outer package member and includes a first electrode and a second electrode. The first electrode and the second electrode are opposed to each other and wound. The first electrode includes a leading end part located on a side close to a center of the battery device. The leading end part is wound once or more on a side closer to the center of the battery device than the second electrode, and includes one or more bent parts. In the one or more bent parts, the leading end part is bent to be partly recessed toward the center of the battery device.

### CROSS REFERENCE TO RELATED APPLICATIONS

The present application is a continuation of PCT patent application no. PCT/JP2022/030722, filed on Aug. 12, 2022, which claims priority to Japanese patent application no. 2021-133214, filed on Aug. 18, 2021, the entire contents of which are incorporated herein by reference.

### BACKGROUND

The present application relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a battery device (a positive electrode, a negative electrode, and an electrolyte) inside an outer package member. A configuration of the secondary battery has been considered in various ways.

Specifically, a positive electrode plate and a negative electrode plate are wound with a separator interposed between the positive electrode plate and the negative electrode plate, and an adhesive tape is applied on a back surface of the negative electrode plate at a location opposed to a start end part on an inner peripheral surface side of a positive electrode mixture layer.

A positive electrode and a negative electrode are wound with a separator interposed between the positive electrode and the negative electrode, and the separator is bonded to the positive electrode over a region from an end of a positive electrode mixture layer on a winding start side to a length corresponding to at least one loop in a winding direction.

An anode and a cathode are wound with a polymer separator interposed between the anode and the cathode, and a core causing uniform expansion of the cathode is disposed at a center around which the anode and the cathode are wound.

A positive electrode plate and a negative electrode plate are wound with a separator interposed between the positive electrode plate and the negative electrode plate. On an innermost side, only the separator is wound a plurality of number of times, and portions of the separator wound the plurality of number of times are integrally bonded together.

### SUMMARY

The present application relates to a secondary battery.

Although consideration has been given in various ways in relation to a configuration of a secondary battery, operational reliability of the secondary battery still remains insufficient. Accordingly, there is room for improvement in terms thereof.

It is therefore desirable to provide a secondary battery that makes it possible to achieve superior operational reliability.

A secondary battery according to an embodiment of the present technology includes an outer package member and a battery device. The outer package member has a columnar shape. The battery device is contained inside the outer package member and includes a first electrode and a second electrode. The first electrode and the second electrode are opposed to each other and wound. The first electrode includes a leading end part located on a side close to a center of the battery device. The leading end part is wound once or more on a side closer to the center of the battery device than the second electrode, and includes one or more bent parts. In the one or more bent parts, the leading end part is bent to be partly recessed toward the center of the battery device.

According to the secondary battery of an embodiment of the present technology, the battery device including the first electrode and the second electrode is contained inside the outer package member having a columnar shape. The first electrode and the second electrode are opposed to each other and wound. The first electrode includes the leading end part located on the side close to the center of the battery device. The leading end part is wound once or more on the side closer to the center of the battery device than the second electrode, and includes one or more bent parts. In the one or more bent parts, the leading end part is bent to be partly recessed toward the center of the battery device. Accordingly, it is possible to achieve superior operational reliability.

Note that effects of the present technology are not necessarily limited to those described herein and may include any of suitable effect, including as described below, in relation to the present technology.

### BRIEF DESCRIPTION OF THE FIGURES

FIG. 1 is a perspective view of a configuration of a secondary battery according to an embodiment of the present technology.

FIG. 2 is an enlarged sectional view of the configuration of the secondary battery illustrated in FIG. 1.

FIG. 3 is an enlarged sectional view of a configuration of a battery device illustrated in FIG. 2.

FIG. 4 is a schematic diagram illustrating a detailed configuration of the battery device illustrated in FIG. 2, where an angle θ is 90°.

FIG. 5 is a schematic diagram illustrating a detailed configuration of the battery device illustrated in FIG. 2, where the angle θ is 270°.

FIG. 6 is a sectional diagram for describing an operation of the secondary battery.

FIG. 7 is a perspective diagram for describing a process of manufacturing the secondary battery.

FIG. 8 is a schematic diagram for describing a process of fabricating the battery device.

FIG. 9 is a schematic diagram illustrating a configuration of a secondary battery of a comparative example.

FIG. 10 is a schematic diagram for describing the process of fabricating a battery device of the secondary battery of the comparative example.

FIG. 11 is a schematic diagram for describing an issue related to the secondary battery of the comparative example.

FIG. 12 is a schematic diagram for describing an advantage of the secondary battery of an embodiment of the present technology.

FIG. 13 is a schematic diagram illustrating a configuration of a secondary battery of an embodiment.

FIG. 14 is a schematic diagram illustrating a configuration of a secondary battery of an embodiment.

FIG. 15 is a schematic diagram illustrating a configuration of a secondary battery of an embodiment.

### DETAILED DESCRIPTION

The present technology is described below in further detail including with reference to the drawings according to an embodiment.

A description is given first of a secondary battery according to an embodiment of the present technology.

The secondary battery to be described here has a columnar three-dimensional shape. As will be described later, the secondary battery has two bottom parts opposed to each other, and a sidewall part coupled to each of the two bottom parts. The secondary battery thus has an outer diameter and a height. Note that the “outer diameter” is a diameter (a maximum diameter) of each of the two bottom parts, and the “height” is a distance (a maximum distance) from one of the bottom parts to another of the bottom parts.

Although a charge and discharge principle of the secondary battery is not particularly limited, the following description deals with a case where a battery capacity is obtained using insertion and extraction of an electrode reactant. The secondary battery includes a positive electrode, a negative electrode, and an electrolyte. The negative electrode has a charge capacity greater than a discharge capacity of the positive electrode. In other words, an electrochemical capacity per unit area of the negative electrode is set to be greater than an electrochemical capacity per unit area of the positive electrode. A reason for this is to prevent the electrode reactant from precipitating on a surface of the negative electrode during charging.

Although not particularly limited in kind, the electrode reactant is specifically a light metal such as an alkali metal or an alkaline earth metal. Specific examples of the alkali metal include lithium, sodium, and potassium. Specific examples of the alkaline earth metal include beryllium, magnesium, and calcium.

Examples are given below of a case where the electrode reactant is lithium. A secondary battery that obtains the battery capacity using insertion and extraction of lithium is what is called a lithium-ion secondary battery. In the lithium-ion secondary battery, lithium is inserted and extracted in an ionic state.

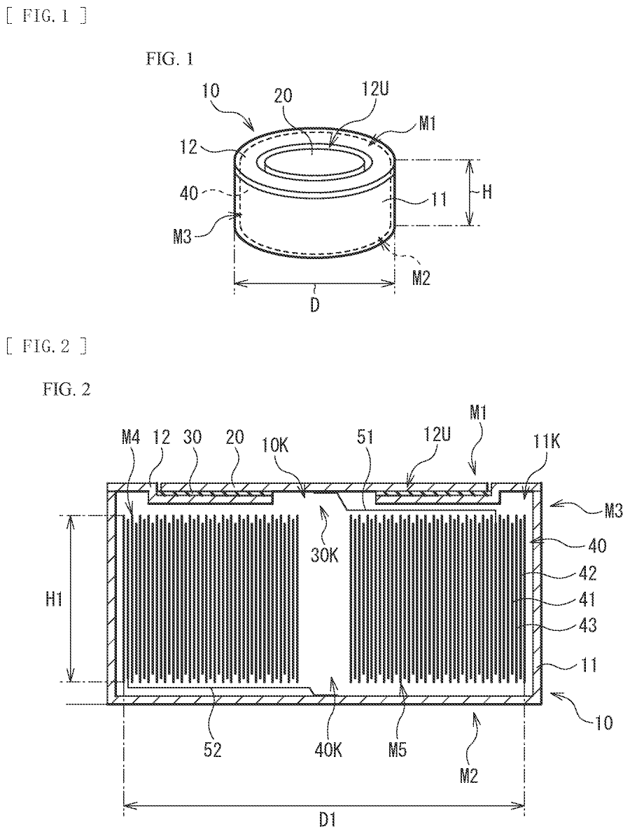

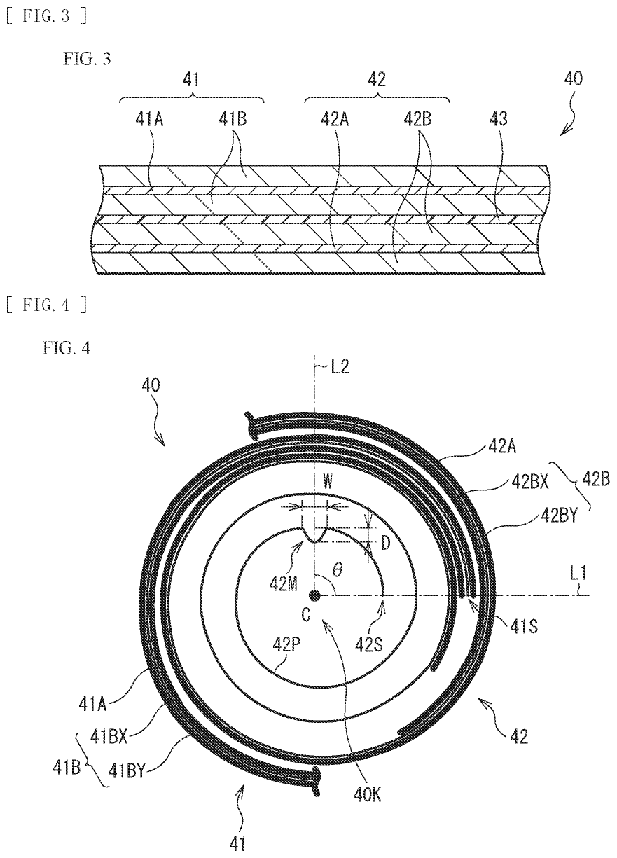

FIG. 1 illustrates a perspective configuration of the secondary battery. FIG. 2 illustrates an enlarged sectional configuration of the secondary battery illustrated in FIG. 1. FIG. 3 illustrates an enlarged sectional configuration of a battery device 40 illustrated in FIG. 2.

Note that in FIG. 2, for simplifying the illustration, a positive electrode 41, a negative electrode 42, a separator 43, a positive electrode lead 51, and a negative electrode lead 52, which will be described later, are each depicted in a linear shape. Further, FIG. 3 illustrates only a portion of the battery device 40.

For convenience, the following description is given with an upper side, a lower side, a right side, and a left side in FIG. 2 assumed to be an upper side, a lower side, a right side, and a left side of the secondary battery, respectively.

The secondary battery illustrated in FIGS. 1 and 2 has a columnar three-dimensional shape as described above, and has an outer diameter D and a height H. Here, the secondary battery has a three-dimensional shape in which the height H is smaller than the outer diameter D, that is, a flat and columnar three-dimensional shape. The secondary battery is thus of a type referred to as a coin type or a button type. More specifically, the three-dimensional shape of the secondary battery is flat and cylindrical (circular columnar), and a ratio D/H of the outer diameter D to the height H is greater than 1.

Specific dimensions of the secondary battery are not particularly limited; however, for example, it is preferable that the outer diameter D fall within a range from 3 mm to 30 mm both inclusive and the height H fall within a range from 0.5 mm to 70 mm both inclusive. Note that the ratio D/H is preferably less than or equal to 25.

As illustrated in FIGS. 1 to 3, the secondary battery includes an outer package can 10 and the battery device 40. Here, the secondary battery further includes an external terminal 20, a gasket 30, the positive electrode lead 51, and the negative electrode lead 52.

As illustrated in FIGS. 1 and 2, the outer package can 10 is a hollow outer package member to contain the battery device 40 and other components. Here, the outer package can 10 has a through hole 10K.

The outer package can 10 has a columnar three-dimensional shape similar to the three-dimensional shape of the secondary battery, that is, a flat and columnar (circular columnar) three-dimensional shape. The outer package can 10 thus has an upper bottom part M1 and a lower bottom part M2 opposed to each other, and a sidewall part M3. The sidewall part M3 is disposed between the upper bottom part M1 and the lower bottom part M2 and coupled to each of the upper bottom part M1 and the lower bottom part M2. Here, the upper bottom part M1 and the lower bottom part M2 are each circular in plan shape, and a surface of the sidewall part M3 is a curved surface that is convex outward.

Here, the outer package can 10 includes a container part 11 and a cover part 12. The container part 11 and the cover part 12 are joined to each other. The container part 11 is thus sealed by the cover part 12. Specifically, as will be described later, the container part 11 and the cover part 12 are welded to each other.

The container part 11 is a circular columnar and substantially bowl-shaped member (the lower bottom part M2 and the sidewall part M3) to contain the battery device 40 and other components inside. Here, the container part 11 has a structure in which the lower bottom part M2 and the sidewall part M3 are integral with each other. However, the container part 11 may have a structure in which the lower bottom part M2 and the sidewall part M3 are separate from each other. The container part 11 has a hollow structure with an upper end open and a lower end closed, and thus has an opening 11K at the upper end.

The cover part 12 is a substantially disk-shaped member (the upper bottom part M1) to close the opening 11K, and has the through hole 10K described above. As will be described later, the through hole 10K is used as a coupling path for electrically coupling the battery device 40 and the external terminal 20 to each other.

In the secondary battery as completed, the cover part 12 has already been joined to the container part 11 as described above, and the opening 11K has thus been closed by the cover part 12. It may thus seem that whether the container part 11 has had the opening 11K is not recognizable afterward from an external appearance of the secondary battery.

If, however, the container part 11 and the cover part 12 have been welded to each other to join the container part 11 and the cover part 12 to each other in a process of manufacturing the secondary battery, welding marks should remain on a surface of the outer package can 10, more specifically, at a boundary between the container part 11 and the cover part 12. Thus, whether the container part 11 has had the opening 11K is recognizable afterward, based on the presence or absence of the welding marks.

Specifically, if the welding marks remain on the surface of the outer package can 10, that is, if the welding marks are visually recognizable, it indicates that the container part 11 has had the opening 11K. In contrast, if no welding marks remain on the surface of the outer package can 10, that is, if no welding marks are visually recognizable, it indicates that the container part 11 has had no opening 11K.

Here, the cover part 12 includes a recessed part 12U, and the through hole 10K is provided in the recessed part 12U. In the recessed part 12U, the cover part 12 is bent to be partly recessed toward an inside of the container part 11. Accordingly, a portion of the cover part 12 is bent to form a downward step.

A shape of the recessed part 12U, that is, a shape defined by an outer edge of the recessed part 12U when the secondary battery is viewed from above is not particularly limited. Here, the recessed part 12U has a circular shape. An inner diameter and a depth of the recessed part 12U are not particularly limited and may be chosen as desired.

As described above, the outer package can 10 includes two members (the container part 11 and the cover part 12) that have been physically separate from each other and are joined to each other. Thus, the outer package can 10 is what is called a joined can. More specifically, the outer package can 10 in which the container part 11 and the cover part 12 are welded to each other is what is called a welded can. Accordingly, the outer package can 10 after joining is physically a single member as a whole, and is in a state of being not separable into the two members (the container part 11 and the cover part 12) afterward.

The outer package can 10 that is a joined can is different from a crimped can formed by means of crimping processing, and is thus what is called a crimpless can. A reason for this is to increase a device space volume inside the outer package can 10 and to thereby increase a volumetric energy density. The “device space volume” refers to a volume (an effective volume) of an internal space of the outer package can 10 available for containing the battery device 40.

Further, the outer package can 10 that is a joined can does not include any portion folded over another portion, and does not include any portion in which two or more members lie over each other.

The wording “does not include any portion folded over another portion” means that the outer package can 10 is not so processed (subjected to bending processing) as to include a portion folded over another portion. The wording “does not include any portion in which two or more members lie over each other” means that the outer package can 10 after completion of the secondary battery is physically a single member and is thus not separable into two or more members afterward. That is, the outer package can 10 in the secondary battery having been completed is not in a state in which two or more members lie over each other and are so combined with each other as to be separable from each other afterward.

Here, the outer package can 10 has an electrical conducting property, and therefore the container part 11 and the cover part 12 each have an electrical conducting property. The outer package can 10 is coupled to the battery device 40, more specifically, to the negative electrode 42 to be described later, via the negative electrode lead 52. Accordingly, the outer package can 10 is electrically coupled to the negative electrode 42. The outer package can 10 thus serves as an external coupling terminal of the negative electrode 42. A reason for this is to make it unnecessary for the secondary battery to include an external coupling terminal of the negative electrode 42 separate from the outer package can 10, and to thereby suppress a decrease in device space volume resulting from providing the external coupling terminal of the negative electrode 42. As a result, the device space volume increases, and the volumetric energy density increases accordingly.

Specifically, the outer package can 10 includes any one or more of electrically conductive materials including, without limitation, a metal material and an alloy material. Specific examples of the electrically conductive materials include iron, copper, nickel, stainless steel, an iron alloy, a copper alloy, and a nickel alloy. The stainless steel is not particularly limited in kind, and specific examples thereof include SUS304 and SUS316. Note that the container part 11 and the cover part 12 may include the same material or may include respective different materials.

As will be described later, the cover part 12 is insulated, via the gasket 30, from the external terminal 20 serving as an external coupling terminal of the positive electrode 41. A reason for this is to prevent contact, or a short circuit, between the outer package can 10 (the external coupling terminal of the negative electrode 42) and the external terminal 20 (the external coupling terminal of the positive electrode 41).

As illustrated in FIGS. 1 and 2, the external terminal 20 is an electrode terminal to be coupled to electronic equipment when the secondary battery is mounted on the electronic equipment. The external terminal 20 is disposed on an outer side of the outer package can 10 and blocks the through hole 10K.

Note that the external terminal 20 is supported by the outer package can 10 with the gasket 30 interposed between the external terminal 20 and the outer package can 10. More specifically, as will be described later, the external terminal 20 is thermally welded to the cover part 12 with the gasket 30 interposed between the external terminal 20 and the cover part 12. As a result, the external terminal 20 is fixed to the cover part 12 with the gasket 30 interposed between the external terminal 20 and the cover part 12, and is insulated from the cover part 12 by the gasket 30.

The external terminal 20 is coupled to the battery device 40 (the positive electrode 41) via the positive electrode lead 51, and is thus electrically coupled to the positive electrode 41. Accordingly, the external terminal 20 serves as the external coupling terminal of the positive electrode 41. Upon use of the secondary battery, the secondary battery is coupled to electronic equipment via the external terminal 20 (the external coupling terminal of the positive electrode 41) and the outer package can 10 (the external coupling terminal of the negative electrode 42). This allows the electronic equipment to operate with use of the secondary battery as a power source.

The external terminal 20 is a substantially plate-shaped member. Specifically, a three-dimensional shape of the external terminal 20 is a flat plate shape, although not particularly limited thereto.

Here, the external terminal 20 is disposed inside the recessed part 12U. More specifically, the external terminal 20 is so placed inside the recessed part 12U as not to protrude outward (upward) from the recessed part 12U. A reason for this is to reduce the height H of the secondary battery to thereby increase the volumetric energy density, as compared with a case where the external terminal 20 protrudes outward from the recessed part 12U.

Note that the external terminal 20 has an outer diameter smaller than the inner diameter of the recessed part 12U. The external terminal 20 is thus separated from the cover part 12 surrounding the external terminal 20. Accordingly, the gasket 30 is disposed in a portion or all of a space between the cover part 12 and the external terminal inside the recessed part 12U. More specifically, the gasket 30 is disposed at a location where the cover part 12 and the external terminal 20 would be in contact with each other if it were not for the gasket 30.

The external terminal 20 includes any one or more of electrically conductive materials including, without limitation, a metal material and an alloy material. Specific examples of the electrically conductive materials include aluminum and an aluminum alloy.

Note that the external terminal 20 may include a cladding material. The cladding material includes an aluminum layer and a nickel layer that are disposed in this order from a side close to the gasket 30. The aluminum layer and the nickel layer are roll-bonded to each other. Note that the cladding material may include a nickel alloy layer instead of the nickel layer.

In addition to serving as the external coupling terminal of the positive electrode 41, the external terminal 20 serves, in particular, as a release valve that releases an internal pressure of the outer package can 10 when the internal pressure excessively increases. Examples of a cause of an increase in the internal pressure include generation of a gas due to a decomposition reaction of an electrolytic solution upon charging and discharging. Examples of a factor accelerating the decomposition reaction of the electrolytic solution include an internal short circuit in the secondary battery, heating of the secondary battery, and discharging of the secondary battery under a large current condition.

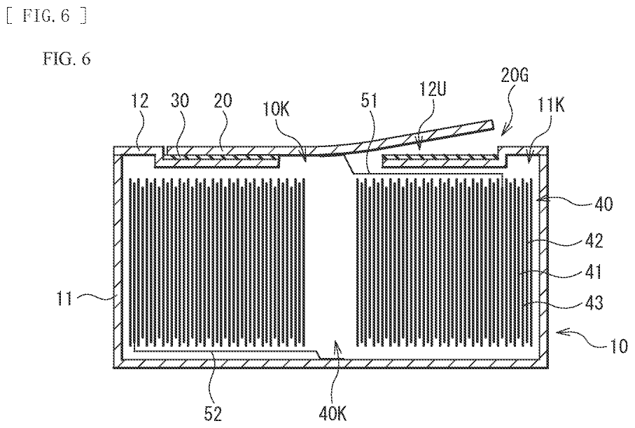

An operation of the external terminal 20 serving as the release valve will be described in detail later (see FIG. 6).

The gasket 30 is an insulating sealing member disposed between the outer package can 10 and the external terminal 20, as illustrated in FIG. 2. Here, the gasket 30 is disposed between the cover part 12 and the external terminal 20, and has a through hole 30K located to overlap the through hole 10K. The gasket 30 is thus so disposed as not to block the through hole 10K. Note that an inner diameter of the through hole 10K and an inner diameter of the through hole 30K may be the same or different from each other.

The gasket 30 includes any one or more of polymer compounds having an insulating property and a hot melt property, and the external terminal 20 is thus thermally welded to the cover part 12 with the gasket 30 interposed between the external terminal 20 and the cover part 12, as described above. The polymer compound is not particularly limited in kind, and specific examples thereof include polypropylene and polyethylene.

A range of placement of the gasket 30 is not particularly limited and may be chosen as desired. Here, the gasket 30 is disposed in a space between a top surface of the cover part 12 and a bottom surface of the external terminal 20 inside the recessed part 12U. Note that the range of placement of the gasket 30 may be extended to an outer side of the space between the top surface of the cover part 12 and the bottom surface of the external terminal 20.

The battery device 40 is a power generation device that causes charging and discharging reactions to proceed, and is contained inside the outer package can 10, as illustrated in FIGS. 1 to 3. The battery device 40 includes the positive electrode 41 as a second electrode, the negative electrode 42 as a first electrode, the separator 43, and the electrolytic solution. The electrolytic solution is a liquid electrolyte, and is not illustrated.

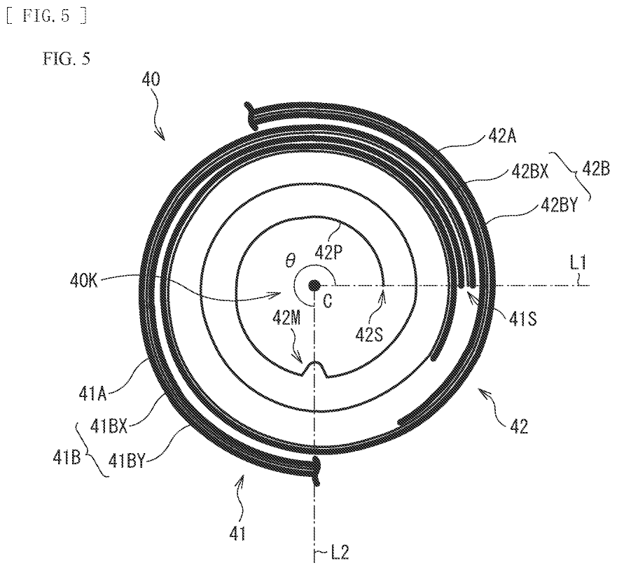

The battery device 40 is what is called a wound electrode body. The battery device 40 therefore has a device structure of what is called a wound type. In this case, the positive electrode 41 and the negative electrode 42 are stacked on each other with the separator 43 interposed between the positive electrode 41 and the negative electrode 42, and the stack of the positive electrode 41, the negative electrode 42, and the separator 43 is wound. As a result, the battery device 40 has a winding center space 40K that is a winding core part. The positive electrode 41 and the negative electrode 42 are thus opposed to each other and wound around the winding center space 40K located at a center C (see FIGS. 4 and 5) of the battery device 40 to be described later.

The battery device 40 has a columnar three-dimensional shape similar to the three-dimensional shape of the outer package can 10, and thus has a flat and circular columnar three-dimensional shape. A reason for this is to prevent a dead space, that is, a surplus space between the outer package can 10 and the battery device 40, from easily resulting when the battery device 40 is placed inside the outer package can 10, and to thereby allow for efficient use of the internal space of the outer package can 10, as compared with a case where the battery device 40 has a three-dimensional shape different from the three-dimensional shape of the outer package can 10. As a result, the device space volume increases, and the volumetric energy density increases accordingly.

As illustrated in FIGS. 2 and 3, the positive electrode 41 includes a positive electrode current collector 41A and a positive electrode active material layer 41B.

The positive electrode current collector 41A is an electrically conductive support that supports the positive electrode active material layer 41B. The positive electrode current collector 41A has two opposed surfaces on each of which the positive electrode active material layer 41B is to be provided. The positive electrode current collector 41A includes an electrically conductive material such as a metal material. Specific examples of the electrically conductive material include aluminum.

Here, the positive electrode active material layer 41B is provided on each of the two opposed surfaces of the positive electrode current collector 41A. The positive electrode active material layer 41B includes any one or more of positive electrode active materials into which lithium is insertable and from which lithium is extractable. Note that the positive electrode active material layer 41B may be provided only on one of the two opposed surfaces of the positive electrode current collector 41A, on a side where the positive electrode 41 is opposed to the negative electrode 42. The positive electrode active material layer 41B may further include any one or more of other materials including, without limitation, a positive electrode binder and a positive electrode conductor. A method of forming the positive electrode active material layer 41B is not particularly limited, and specific examples thereof include a coating method.

The positive electrode active material includes a lithium compound. A reason for this is that a high energy density is obtainable. The lithium compound is a compound that includes lithium as a constituent element, and more specifically, a compound that includes lithium and one or more transition metal elements as constituent elements. Note that the lithium compound may further include any one or more of other elements, i.e., elements other than lithium and transition metal elements.

Although not particularly limited in kind, the lithium compound is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes any one or more of materials including, without limitation, a synthetic rubber and a polymer compound. Specific examples of the synthetic rubber include a styrene-butadiene-based rubber. Specific examples of the polymer compound include polyvinylidene difluoride. The positive electrode conductor includes any one or more of electrically conductive materials including, without limitation, a carbon material. Specific examples of the electrically conductive materials include graphite, carbon black, acetylene black, and Ketjen black. Note that the electrically conductive material may be a metal material or a polymer compound, for example.

As illustrated in FIGS. 2 and 3, the negative electrode 42 includes a negative electrode current collector 42A and a negative electrode active material layer 42B. The negative electrode current collector 42A is a current collector of the negative electrode 42 that is the first electrode. The negative electrode active material layer 42B is an active material layer of the negative electrode 42 that is the first electrode.

The negative electrode current collector 42A is an electrically conductive support that supports the negative electrode active material layer 42B. The negative electrode current collector 42A has two opposed surfaces on each of which the negative electrode active material layer 42B is to be provided. The negative electrode current collector 42A includes an electrically conductive material such as a metal material. Specific examples of the electrically conductive material include copper.

The negative electrode active material layer 42B is provided on the negative electrode current collector 42A. Here, the negative electrode active material layer 42B is provided on each of the two opposed surfaces of the negative electrode current collector 42A. The negative electrode active material layer 42B includes any one or more of negative electrode active materials into which lithium is insertable and from which lithium is extractable. Note that the negative electrode active material layer 42B may be provided only on one of the two opposed surfaces of the negative electrode current collector 42A, on a side where the negative electrode 42 is opposed to the positive electrode 41. The negative electrode active material layer 42B may further include any one or more of other materials including, without limitation, a negative electrode binder and a negative electrode conductor. Details of the negative electrode binder are similar to the details of the positive electrode binder. Details of the negative electrode conductor are similar to the details of the positive electrode conductor. A method of forming the negative electrode active material layer 42B is not particularly limited, and specifically includes any one or more of methods including, without limitation, a coating method, a vapor-phase method, a liquid-phase method, a thermal spraying method, and a firing (sintering) method.

The negative electrode active material includes any one or more of materials including, without limitation, a carbon material and a metal-based material. A reason for this is that a high energy density is obtainable. Specific examples of the carbon material include graphitizable carbon, non-graphitizable carbon, and graphite (natural graphite and artificial graphite). The metal-based material is a material that includes, as one or more constituent elements, any one or more elements among metal elements and metalloid elements that are each able to form an alloy with lithium. Specific examples of such metal elements and metalloid elements include silicon and tin. Note that the metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Note that the negative electrode 42 is disposed on an inner winding side relative to the positive electrode 41, and includes a bent part 42M on an inner circumference side. A detailed configuration of the battery device 40 including the negative electrode 42 (the bent part 42M) will be described later (see FIGS. 4 and 5).

The separator 43 is an insulating porous film interposed between the positive electrode 41 and the negative electrode 42, as illustrated in FIGS. 2 and 3. The separator 43 prevents a short circuit between the positive electrode 41 and the negative electrode 42 and allows lithium ions to pass therethrough. The separator 43 includes a polymer compound such as polyethylene. The electrolytic solution includes a solvent and an electrolyte salt. The positive electrode 41, the negative electrode 42, and the separator 43 are each impregnated with the electrolytic solution.

Here, the solvent includes any one or more of non-aqueous solvents (organic solvents). An electrolytic solution that includes the non-aqueous solvent(s) is what is called a non-aqueous electrolytic solution. The non-aqueous solvent is, for example, an ester or an ether, more specifically, a carbonic-acid-ester-based compound, a carboxylic-acid-ester-based compound, or a lactone-based compound, for example.

The carbonic-acid-ester-based compound is a cyclic carbonic acid ester or a chain carbonic acid ester, for example. Specific examples of the cyclic carbonic acid ester include ethylene carbonate and propylene carbonate. Specific examples of the chain carbonic acid ester include dimethyl carbonate, diethyl carbonate, and ethyl methyl carbonate. The carboxylic-acid-ester-based compound is a chain carboxylic acid ester, for example. Specific examples of the chain carboxylic acid ester include methyl acetate, ethyl acetate, methyl propionate, ethyl propionate, propyl propionate, ethyl trimethylacetate, methyl butyrate, and ethyl butyrate. The lactone-based compound is a lactone, for example. Specific examples of the lactone include γ-butyrolactone and γ-valerolactone. Note that the ether may be the lactone-based compound described above, 1,2-dimethoxyethane, tetrahydrofuran, 1,3-dioxolane, or 1,4-dioxane, for example.

The electrolyte salt is a light metal salt such as a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), and lithium difluoro(oxalato)borate (LiB(C₂O₄)F₂).

A content of the electrolyte salt is not particularly limited, and is specifically within a range from 0.3 mol/kg to 3.0 mol/kg both inclusive with respect to the solvent. A reason for this is that high ion conductivity is obtainable.

The positive electrode lead 51 is a wiring member for electrically coupling the positive electrode 41 to the external terminal 20, and is contained inside the outer package can 10, as illustrated in FIG. 2. The positive electrode lead 51 is coupled to each of the positive electrode current collector 41A of the positive electrode 41 and the external terminal 20 through the through hole 10K, and is thus electrically coupled to each of the positive electrode 41 and the external terminal 20. Note that the positive electrode lead 51 is coupled to the positive electrode 41 on a side close to the cover part 12.

Here, the secondary battery includes one positive electrode lead 51. Note that the secondary battery may include two or more positive electrode leads 51. An increase in the number of the positive electrode leads 51 results in a decrease in electrical resistance of the battery device 40.

Details of a material included in the positive electrode lead 51 are similar to the details of the material included in the positive electrode current collector 41A. Note that the material included in the positive electrode lead 51 and the material included in the positive electrode current collector 41A may be the same or different from each other.

Here, the positive electrode lead 51 is physically separate from the positive electrode current collector 41A and is thus provided separately from the positive electrode current collector 41A. Alternatively, the positive electrode lead 51 may be physically continuous with the positive electrode current collector 41A and may thus be provided integrally with the positive electrode current collector 41A.

The negative electrode lead 52 is a wiring member for electrically coupling the negative electrode 42 to the outer package can 10, and is contained inside the outer package can 10, as illustrated in FIG. 2. The negative electrode lead 52 is coupled to each of the negative electrode current collector 42A of the negative electrode 42 and the container part 11, and is thus electrically coupled to each of the negative electrode 42 and the outer package can 10. Note that the negative electrode lead 52 is coupled to the negative electrode 42 on a side away from the cover part 12, and is thus coupled to the lower bottom part M2.

Here, the secondary battery includes one negative electrode lead 52. Note that the secondary battery may include two or more negative electrode leads 52. An increase in the number of the negative electrode leads 52 results in a decrease in electrical resistance of the battery device 40.

Details of a material included in the negative electrode lead 52 are similar to the details of the material included in the negative electrode current collector 42A. Note that the material included in the negative electrode lead 52 and the material included in the negative electrode current collector 42A may be the same or different from each other.

The negative electrode lead 52 is physically separate from the negative electrode current collector 42A and is thus provided separately from the negative electrode current collector 42A. Alternatively, the negative electrode lead 52 may be physically continuous with the negative electrode current collector 42A and may thus be provided integrally with the negative electrode current collector 42A.

Note that the secondary battery may further include any one or more of other components that are unillustrated.

Specifically, examples of the other components include an insulating film disposed between the cover part 12 and the battery device 40. A portion of the insulating film is disposed between the container part 11 and the positive electrode lead 51. The insulating film has a through hole located to overlap the through hole 10K. Thus, the insulating film is so disposed as not to block the through hole 10K. Further, the insulating film includes any one or more of insulating materials including, without limitation, an insulating polymer compound. Specific examples of the insulating materials include polyimide.

Examples of the other components further include another insulating film disposed between the container part 11 (the lower bottom part M2) and the battery device 40. In this case, a portion of the other insulating film is disposed between the container part 11 and the negative electrode lead 52. A configuration of the other insulating film is similar to the configuration of the foregoing insulating film. A material included in the other insulating film is similar to the material included in the foregoing insulating film.

Examples of the other components further include a sealant (an insulating covering member) that covers a surface of the positive electrode lead 51. The sealant has a tube-shaped structure and thus covers a periphery of the positive electrode lead 51. As a result, the positive electrode lead 51 is insulated from each of the outer package can 10 and the negative electrode 42 by the sealant. A material included in the sealant is similar to the material included in the foregoing insulating film.

FIGS. 4 and 5 each illustrate a detailed schematic configuration of the battery device 40 illustrated in FIG. 2.

Note that FIGS. 4 and 5 each illustrate only a portion of the battery device 40 in the vicinity of the winding center space 40K, and more specifically, a wound state of the positive electrode 41 and the negative electrode 42 as viewed in a direction of extension of the winding center space 40K, that is, as viewed from above. In this case, the illustration of the separator 43 is omitted.

In each of FIGS. 4 and 5, for simplifying the illustration, the positive electrode current collector 41A and the negative electrode current collector 42A are each illustrated in a thin line, and the positive electrode active material layers 41B and the negative electrode active material layers 42B are each illustrated in a thick line. In this case, for easy distinction between the positive electrode current collector 41A and the positive electrode active material layers 41B, a small spacing is provided between the positive electrode current collector 41A and each of the positive electrode active material layers 41B. Similarly, for easy distinction between the negative electrode current collector 42A and the negative electrode active material layers 42B, a small spacing is provided between the negative electrode current collector 42A and each of the negative electrode active material layers 42B.

In the following description, where appropriate, FIGS. 2 and 3 described already above will be referenced in addition to FIGS. 4 and 5.

As illustrated in FIGS. 4 and 5, the positive electrode 41 and the negative electrode 42 are opposed to each other and wound around the winding center space 40K located at the center C of the battery device 40.

The positive electrode active material layers 41B include an inner winding side layer 41BX and an outer winding side layer 41BY. The inner winding side layer 41BX is provided on one of the surfaces of the positive electrode current collector 41A that is located on the inner winding side. The outer winding side layer 41BY is provided on another of the surfaces of the positive electrode current collector 41A that is located on an outer winding side. The negative electrode active material layers 42B include an inner winding side layer 42BX and an outer winding side layer 42BY. The inner winding side layer 42BX is provided on one of the surfaces of the negative electrode current collector 42A that is located on the inner winding side. The outer winding side layer 42BY is provided on another of the surfaces of the negative electrode current collector 42A that is located on the outer winding side.

The “inner winding side” refers to an inner side in a radial direction of the battery device 40, which is the wound electrode body, when the battery device 40 is viewed in a direction of extension of the winding center space 40K, that is, in a direction intersecting a sheet plane of each of FIGS. 4 and 5. More specifically, the “inner winding side” refers to an inner side (a side close to the center C) in a direction along a straight line L1 to be described later. Note that an outer side in the radial direction of the battery device 40, that is, an outer side (a side away from the center C) in the direction along the straight line L1, is the “outer winding side”.

The positive electrode 41 and the negative electrode 42 are so wound that the negative electrode 42 is disposed on the inner winding side relative to the positive electrode 41. Accordingly, in a process of fabricating the battery device 40, as will be described later, the positive electrode 41 and the negative electrode 42 are stacked on each other with the separator 43 interposed between the positive electrode 41 and the negative electrode 42, following which the stack of the positive electrode 41, the negative electrode 42, and the separator 43 is wound in a state in which the negative electrode 42 is disposed on the inner winding side and the positive electrode 41 is disposed on the outer winding side.

The positive electrode 41 has a leading end 41S on the inner circumference side. The negative electrode 42 has a leading end 42S on the inner circumference side. The leading end 42S is located on the inner circumference side relative to the leading end 41S.

The “inner circumference side” refers to the inner side (the side close to C) in a winding direction (a direction of spiral winding) of each of the positive electrode 41 and the negative electrode 42. More specifically, the “inner circumference side” refers to the inner side in a longitudinal direction of each of the positive electrode 41 and the negative electrode 42. Note that the outer side (the side away from the center C) in the winding direction, that is, the outer side in the longitudinal direction of each of the positive electrode 41 and the negative electrode 42 is an “outer circumference side”.

Here, the negative electrode 42, which is disposed on the inner winding side relative to the positive electrode 41, includes a leading end part 42P as an end part located on the inner circumference side. The leading end part 42P is wound on a side closer to the center C than the positive electrode 41. Here, in the leading end part 42P, no negative electrode active material layer 42B (neither the inner winding side layer 42BX nor the outer winding side layer 42BY) is provided on the negative electrode current collector 42A. In other words, in the leading end part 42P, neither of the two opposed surfaces of the negative electrode current collector 42A is covered by corresponding one of the inner winding side layer 42BX and the outer winding side layer 42BY, and the negative electrode current collector 42A is thus exposed. As a result, the leading end part 42P is wound in a state of being not opposed to the positive electrode 41. A reason for this is that this cuts down a weight of the negative electrode active material layers 42B not contributing to charging and discharging reactions in the leading end part 42P not opposed to the positive electrode 41, and thereby allows for an increase in gravimetric energy density. Note that in the leading end part 42P, the inner winding side layer 42BX, the outer winding side layer 42BY, or both may be provided on the negative electrode current collector 42A.

A leading end of the inner winding side layer 42BX on the inner circumference side and a leading end of the outer winding side layer 42BY on the inner circumference side may be located at the same position or at respective different positions. Here, the leading end of the outer winding side layer 42BY is located on the inner circumference side relative to the leading end of the inner winding side layer 42BX, and therefore the position of the leading end of the inner winding side layer 42BX and the position of the leading end of the outer winding side layer 42BY are different from each other in the winding direction.

Note that the positive electrode 41, which is disposed on the outer winding side relative to the negative electrode 42, may or may not include, as an end part located on the inner circumference side, a portion in which no positive electrode active material layer 41B (neither the inner winding side layer 41BX nor the outer winding side layer 41BY) is provided on the positive electrode current collector 41A. Here, the positive electrode 41 does not include the portion in which no positive electrode active material layer 41B is provided on the positive electrode current collector 41A, and therefore the positive electrode current collector 41A is unexposed, with each of the two opposed surfaces of the positive electrode current collector 41A being entirely covered by corresponding one of the inner winding side layer 41BX and the outer winding side layer 41BY.

A leading end of the inner winding side layer 41BX on the inner circumference side and a leading end of the outer winding side layer 41BY on the inner circumference side may be located at the same position or at respective different positions. Here, the position of the leading end of the inner winding side layer 41BX and the position of the leading end of the outer winding side layer 41BY are coincident with each other. Note that the respective leading ends of the inner winding side layer 41BX and the outer winding side layer 41BY are located on the outer circumference side relative to the respective leading ends of the inner winding side layer 42BX and the outer winding side layer 42BY.

The position of each of the leading ends 41S and 42S is not particularly limited and may be chosen as desired. FIGS. 4 and 5 each illustrate a case where the leading ends 41S and 42S are each located at a position along the straight line LI to be described later.

The leading end part 42P is wound once or more, and the leading end 41S of the positive electrode 41 is located on the outer circumference side relative to the leading end part 42P. Here, the leading end part 42P is wound approximately twice.

The leading end part 42P of the negative electrode 42, which is disposed on the inner winding side relative to the positive electrode 41, includes a bent part 42M. The number of the bent parts 42M may be one or more. FIGS. 4 and 5 each illustrate a case where the number of the bent parts 42M is one.

In the bent part 42M, the leading end part 42P is bent to be partly recessed toward the center C. Here, in the bent part 42M, the negative electrode current collector 42A that is exposed and not covered by the negative electrode active material layers 42B (the inner winding side layer 42BX and the outer winding side layer 42BY) is bent midway to be brought closer to the center C and then bent again away from the center C. A width W and a depth D of the bent part 42M are not particularly limited and may be chosen as desired.

Note that, a bent shape of the leading end part 42P in the bent part 42M is not particularly limited as long as the leading end part 42P is bent to be partly recessed. That is, the leading end part 42P may be bent to form a recessed corner of a sharp angle, or may be bent to form a curved recessed corner. FIG. 4 illustrates a case where the leading end part 42P is bent to form a curved recessed corner.

A reason for providing the bent part 42M in the leading end part 42P is that the bent part 42M helps to prevent buckling from easily occurring inside the battery device 40 and to thereby suppress the occurrence of a short circuit, that is, contact between the positive electrode current collector 41A and the negative electrode current collector 42A in the battery device 40 when the secondary battery is charged and discharged. Details of a reason why the bent part 42M helps to suppress the occurrence of a short circuit will be described later.

The position of the bent part 42M, that is, the position in the leading end part 42P where the bent part 42M is to be provided, is not particularly limited. A reason for this is that as long as the leading end part 42P includes the bent part 42M, a short circuit is prevented from easily occurring upon charging and discharging irrespective of the position of the bent part 42M, as compared with when the leading end part 42P is without the bent part 42M.

In particular, the bent part 42M is preferably located at a predetermined position that is determined based on an angle θ to be described later.

Specifically, the straight line L1 and a straight line L2 are defined. The straight line L1 is a first straight line that couples the center C of the battery device 40 and the leading end 41S of the positive electrode 41 to each other. The straight line L2 is a second straight line that couples the center C and a center of the bent part 42M to each other. The center of the bent part 42M is a position that bisects the width W of the bent part 42M. The straight line L2 is used to determine the position of the bent part 42M with respect to the straight line L1. Thus, the position of the bent part 42M is determined based on the angle θ defined by the straight lines L1 and L2, as described above.

The angle θ preferably falls within a range from 15° to 345° both inclusive. More preferably, the angle θ falls within a range from 15° to 165° both inclusive or a range from 195° to 345° both inclusive. A reason for this is that this further prevents buckling from easily occurring inside the battery device 40, and therefore allows for further suppression of the occurrence of a short circuit.

More specifically, when the leading end part 42P includes one bent part 42M, the bent part 42M is preferably at a position substantially orthogonal to the straight line L1. In other words, the angle θ preferably falls within a range from 75° to 105° both inclusive, as illustrated in FIG. 4. Alternatively, the angle θ preferably falls within a range from 255° to 285° both inclusive, as illustrated in FIG. 5.

Further, a wind of the leading end part 42P in which the bent part 42M is to be provided is not particularly limited. Specifically, as described above, when the leading end part 42P is wound approximately twice, the bent part 42M may be provided in an inner wind (the first wind from the center C) of the leading end part 42P or in an outer wind (the second wind from the center C) of the winding of the leading end part 42P. Needless to say, when the number of the bent parts 42M is two or more, one or more of the bent parts 42M may be provided in each of the inner wind (the first wind) and the outer wind (the second wind).

As illustrated in FIG. 2, the battery device 40 has an outer diameter D1 and a height H1, and has a flat and circular columnar three-dimensional shape in which the height H1 is smaller than the outer diameter D1, as described above. The battery device 40 has an upper bottom part M4 and a lower bottom part M5 which are two bottom parts opposed to each other. The height H1 is therefore a distance between the upper bottom part M4 and the lower bottom part M5. The outer diameter D1 and the height H1 are each not particularly limited and may be chosen as desired in relation to the above-described dimensions of the secondary battery including the outer diameter D, the height H, and the ratio D/H.

In particular, because the height H1 is smaller than the outer diameter D1, the battery device 40 preferably has a flat and columnar three-dimensional shape, as described above. A reason for this is that the occurrence of a short circuit is sufficiently suppressed in the battery device 40 even in a small-sized secondary battery.

To be more specific, when the height H1 is greater than the outer diameter D1, an area over which the positive electrode 41 and the negative electrode 42 are opposed to each other is larger, and accordingly, a frictional force occurring between the positive electrode 41 and the negative electrode 42 is higher. This makes the battery device 40 more prone to being irregularly deformed due to, for example, an internal stress occurring upon charging and discharging. As a result, it can be difficult to sufficiently suppress the occurrence of a short circuit in the battery device 40.

In contrast, when the height H1 is smaller than the outer diameter D1, the area over which the positive electrode 41 and the negative electrode 42 are opposed to each other is smaller, and accordingly, the frictional force occurring between the positive electrode 41 and the negative electrode 42 is lower. This makes the battery device 40 less prone to being irregularly deformed. As a result, the occurrence of a short circuit is sufficiently suppressed in the battery device 40. In this case, in particular, even if the battery device 40 becomes deformed, an internal stress occurring upon the deformation easily concentrates on the center C. Thus, as described above, the bent part 42M helps to effectively prevent buckling from easily occurring inside the battery device 40.

FIG. 6 illustrates a sectional configuration corresponding to FIG. 2 to describe operations of the secondary battery. In the following, a description is given first of an operation at the time of charging and discharging, and thereafter of an operation at the time of occurrence of an abnormal condition.

Upon charging, in the battery device 40, lithium is extracted from the positive electrode 41, and the extracted lithium is inserted into the negative electrode 42 via the electrolytic solution. Upon discharging, in the battery device 40, lithium is extracted from the negative electrode 42, and the extracted lithium is inserted into the positive electrode 41 via the electrolytic solution. Upon the charging and the discharging, lithium is inserted and extracted in an ionic state.

As described above, the external terminal 20 is disposed on the outer side of the cover part 12 and is thermally welded to the cover part 12 with the gasket 30 interposed between the external terminal 20 and the cover part 12. Accordingly, under normal conditions, as illustrated in FIG. 2, the external terminal 20 is fixed to the cover part 12 with the gasket 30 interposed between the external terminal 20 and the cover part 12. Thus, the through hole 10K is blocked by the external terminal 20, and the outer package can 10 is sealed. As a result, the battery device 40 is sealed in the outer package can 10.

In contrast, upon the occurrence of an abnormal condition, that is, upon an excessive increase in the internal pressure of the outer package can 10, the external terminal 20 is pushed outward (upward) through the through hole 10K due to the increased internal pressure. In this case, if a strength of a force pushing the external terminal 20 outward becomes higher than a strength (what is called a seal strength) by which the external terminal 20 is fixed to the cover part 12 with the gasket 30 interposed between the external terminal 20 and the cover part 12, the external terminal 20 becomes separated, as illustrated in FIG. 6, partially or entirely from the cover part 12. This forms a gap 20G (a release path of the internal pressure) between the cover part 12 and the external terminal 20, allowing the internal pressure to be released through the gap 20G. FIG. 6 illustrates a case where the external terminal 20 has become separated partially from the cover part 12.

As described above, the cover part 12 is joined to the container part 11, whereas the external terminal 20 is thermally welded to the cover part 12 with the gasket 30 interposed between the external terminal 20 and the cover part 12. Accordingly, the above-described seal strength is lower than a joining strength of the cover part 12 to the container part 11. In this case, if the internal pressure of the outer package can 10 excessively increases, the external terminal 20 becomes separated from the cover part 12 before the cover part 12 becomes separated from the container part 11, that is, before the outer package can 10 is broken. In this way, the external terminal 20 operates as a release valve before the outer package can 10 ruptures. A rupture of the outer package can 10 is thereby prevented.

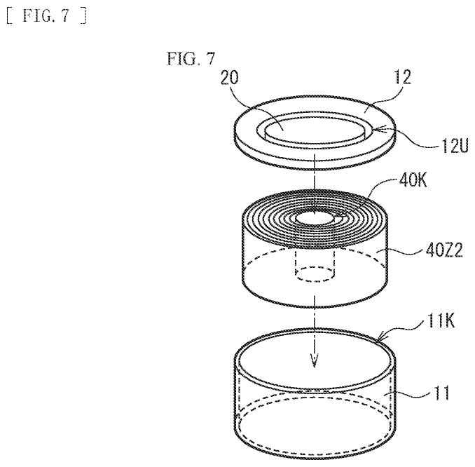

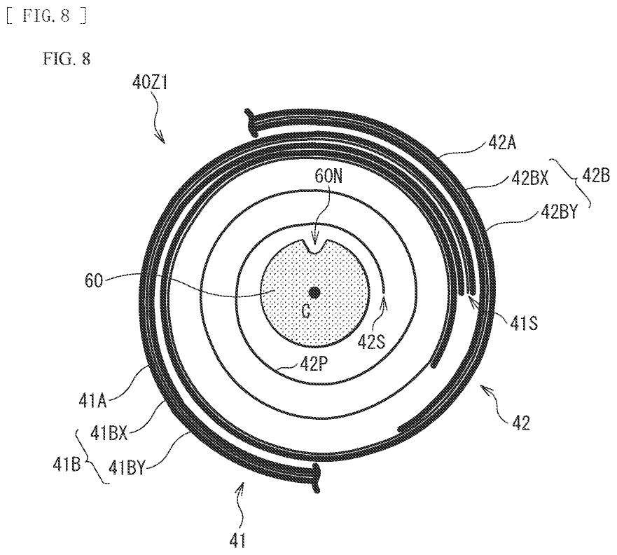

FIG. 7 illustrates a perspective configuration corresponding to FIG. 1 to describe the process of manufacturing the secondary battery. FIG. 8 illustrates a schematic configuration corresponding to FIG. 4 to describe the process of fabricating the battery device 40.

Note that FIG. 7 illustrates a state before joining the cover part 12 to the container part

11. The cover part 12 is thus separate from the container part 11 in FIG. 7. FIG. 8 illustrates a process of winding each of the positive electrode 41 and the negative electrode 42. The bent part 42M is thus not yet formed in the leading end part 42P in FIG. 8. Note that in FIG. 8, for easy distinction between the leading end part 42P and a jig 60 to be described later, a small spacing is provided between the leading end part 42P and the jig 60, and the jig 60 is shaded.

When manufacturing the secondary battery, in accordance with an example procedure described below, the positive electrode 41 and the negative electrode 42 are fabricated and the electrolytic solution is prepared, following which the secondary battery is assembled using the positive electrode 41, the negative electrode 42, and the electrolytic solution, and the secondary battery after being assembled is subjected to a stabilization process.

In the following description, where appropriate, FIGS. 1 to 4 described already above will be referenced in addition to FIGS. 7 and 8. More specifically, a description is given below of a method of manufacturing the secondary battery where the leading end part 42P includes one bent part 42M (angle θ=90°) (FIG. 4).

Here, as illustrated in FIG. 7, the container part 11 and the cover part 12 that are physically separate from each other are used to form the outer package can 10. As described above, the container part 11 has the opening 11K, and the cover part 12 includes the recessed part 12U. Further, as described above, the external terminal 20 is thermally welded to the cover part 12 in advance, with the gasket 30 interposed between the external terminal 20 and the cover part 12.

As illustrated in FIG. 8, the jig 60 having a substantially tubular shape is used to form the battery device 40. The jig 60 extends in a direction intersecting the sheet plane of FIG. 8, and includes a recessed part 60N extending in that direction. The recessed part 60N has a shape corresponding to the shape of the bent part 42M.

First, a positive electrode mixture that is a mixture of the positive electrode active material, the positive electrode binder, and the positive electrode conductor is put into a solvent to thereby prepare a positive electrode mixture slurry in paste form. The solvent may be an aqueous solvent or an organic solvent. The details of the solvent described here apply also to the description below. Thereafter, the positive electrode mixture slurry is applied on the two opposed surfaces of the positive electrode current collector 41A to thereby form the positive electrode active material layers 41B (the inner winding side layer 41BX and the outer winding side layer 41BY). Lastly, the positive electrode active material layers 41B are compression-molded by means of, for example, a roll pressing machine. In this case, the positive electrode active material layers 41B may be heated. The positive electrode active material layers 41B may be compression-molded multiple times. In this manner, the respective positive electrode active material layers 41B are formed on the two opposed surfaces of the positive electrode current collector 41A. The positive electrode 41 is thus fabricated.

First, a negative electrode mixture that is a mixture of the negative electrode active material, the negative electrode binder, and the negative electrode conductor is put into a solvent to thereby prepare a negative electrode mixture slurry in paste form. Thereafter, the negative electrode mixture slurry is applied on the two opposed surfaces of the negative electrode current collector 42A to thereby form the negative electrode active material layers 42B (the inner winding side layer 42BX and the outer winding side layer 42BY). In this case, a range of application of the negative electrode mixture slurry is adjusted to form the leading end part 42P in which no negative electrode active material layers 42B are provided on the negative electrode current collector 42A. Lastly, the negative electrode active material layers 42B are compression-molded by means of, for example, a roll pressing machine. Details of the compression molding of the negative electrode active material layers 42B are similar to the details of the compression molding of the positive electrode active material layers 41B. In this manner, the respective negative electrode active material layers 42B are formed on the two opposed surfaces of the negative electrode current collector 42A. The negative electrode 42 including the leading end part 42P is thus fabricated.

The electrolyte salt is put into the solvent. The electrolyte salt is thereby dispersed or dissolved in the solvent. The electrolytic solution is thus prepared.

First, the positive electrode lead 51 is coupled to the positive electrode current collector 41A of the positive electrode 41 by means of, for example, a welding method, and the negative electrode lead 52 is coupled to the negative electrode current collector 42A of the negative electrode 42 by means of, for example, a welding method.

Thereafter, the positive electrode 41 with the positive electrode lead 51 coupled thereto and the negative electrode 42 with the negative electrode lead 52 coupled thereto are stacked on each other with the separator 43 interposed between the positive electrode 41 and the negative electrode 42. A stacked body 40Z1 is thereby formed as illustrated in FIG. 8. Thereafter, the stacked body 40Z1 is wound around the jig 60, following which the jig 60 is removed.

In this case, the negative electrode 42 is caused to be located on the inner winding side relative to the positive electrode 41, and the leading end 42S is caused to be located on the inner circumference side relative to the leading end 41S. Further, the leading end part 42P is wound once or more, and the leading end 41S is caused to be located on the outer circumference side relative to the leading end part 42P. In this way, the leading end part 42P is disposed over the recessed part 60N provided in the jig 60.

As a result, as illustrated in FIG. 7, a wound body 40Z2 having the winding center space 40K is formed. The wound body 40Z2 has a configuration similar to the configuration of the battery device 40 except that the positive electrode 41, the negative electrode 42, and the separator 43 are each unimpregnated with the electrolytic solution. FIG. 7 omits the illustration of each of the positive electrode lead 51 and the negative electrode lead 52.

When the negative electrode 42 is wound around the jig 60 in the process of forming the wound body 40Z2, a portion of the leading end part 42P is pressed against the jig 60 owing to a tension generated in winding the negative electrode 42, and accordingly, the portion of the leading end part 42P is deformed to be along an inner wall face of the recessed part 60N. The portion of the leading end part 42P is thereby bent to be along the inner wall face of the recessed part 60N, which forms the bent part 42M in the leading end part 42P.

Thereafter, the wound body 40Z2 is placed into the container part 11 through the opening 11K. In this case, the direction of extension of the winding center space 40K is caused to be substantially parallel to a direction in which the wound body 40Z2 is placed into the container part 11. Further, the negative electrode lead 52 is coupled to the container part 11 by means of, for example, a welding method.

Thereafter, the positive electrode lead 51 is coupled to the external terminal 20 through the through hole 10K by means of, for example, a welding method. The external terminal 20 has been thermally welded to the cover part 12 in advance, with the gasket 30 interposed between the external terminal 20 and the cover part 12.

Thereafter, the electrolytic solution is injected into the container part 11 through the opening 11K. The wound body 40Z2 (including the positive electrode 41, the negative electrode 42, and the separator 43) is thereby impregnated with the electrolytic solution. Thus, the battery device 40 is fabricated. In this case, the electrolytic solution is partly supplied into the winding center space 40K, and the winding center space 40K is thus used as a supply path of the electrolytic solution. This makes it easier for the wound body 40Z2 to be impregnated with the electrolytic solution.

Thereafter, the cover part 12 is joined to the container part 11 by means of, for example, a welding method. This forms the outer package can 10 and allows the battery device 40 to be contained inside the outer package can 10. The secondary battery is thus assembled, as illustrated in FIG. 2.

The secondary battery after being assembled is charged and discharged. Various conditions including, for example, an environment temperature, the number of times of charging and discharging (the number of cycles), and charging and discharging conditions, may be chosen as desired. As a result, a film is formed on a surface of each of the positive electrode 41 and the negative electrode 42 in the battery device 40. This brings the secondary battery into an electrochemically stable state.

As a result, the battery device 40 and other components are sealed in the outer package can 10. Thus, the secondary battery is completed.

According to the secondary battery, the battery device 40 including the positive electrode 41 and the negative electrode 42 is contained inside the outer package can 10 having a columnar shape. The positive electrode 41 and the negative electrode 42 are opposed to each other and wound. The negative electrode 42 includes the leading end part 42P located on the side close to the center C of the battery device 40. The leading end part 42P is wound once or more on the side closer to the center C than the positive electrode 41. Further, the leading end part 42P includes the bent part 42M. In the bent part 42M, the leading end part 42P is bent to be partly recessed toward the center C. Accordingly, for a reason described below, it is possible to achieve superior operational reliability.

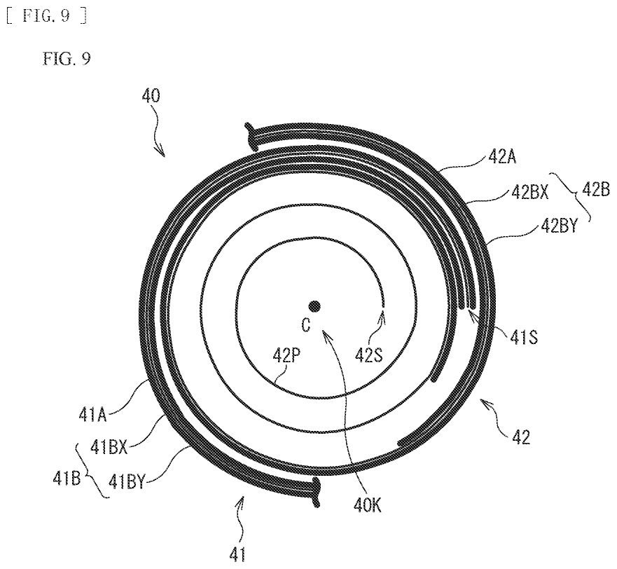

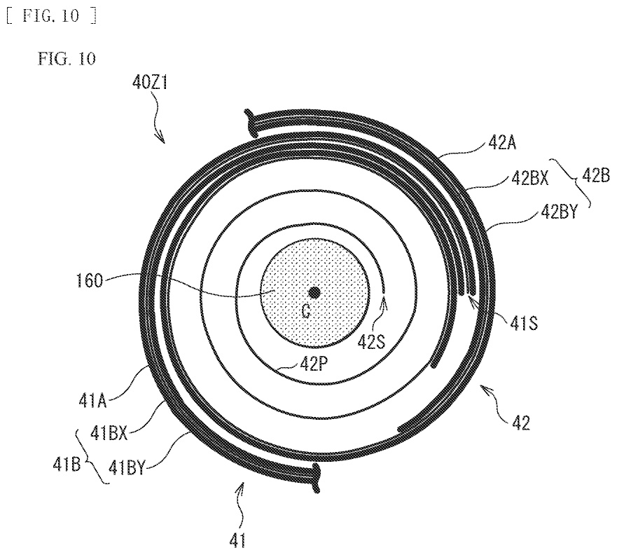

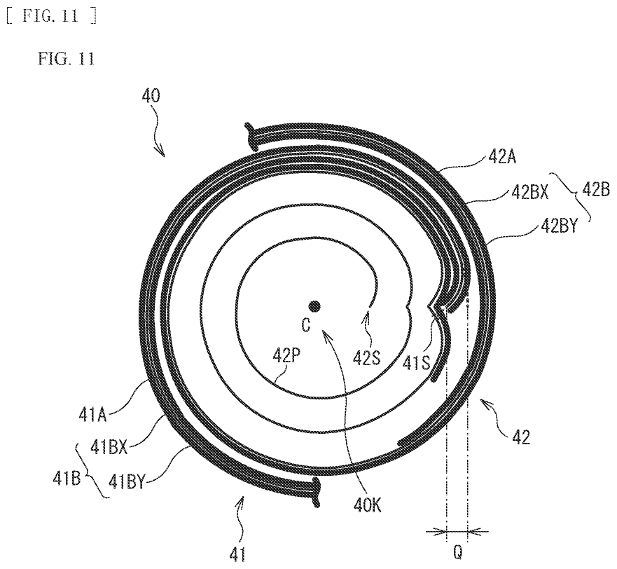

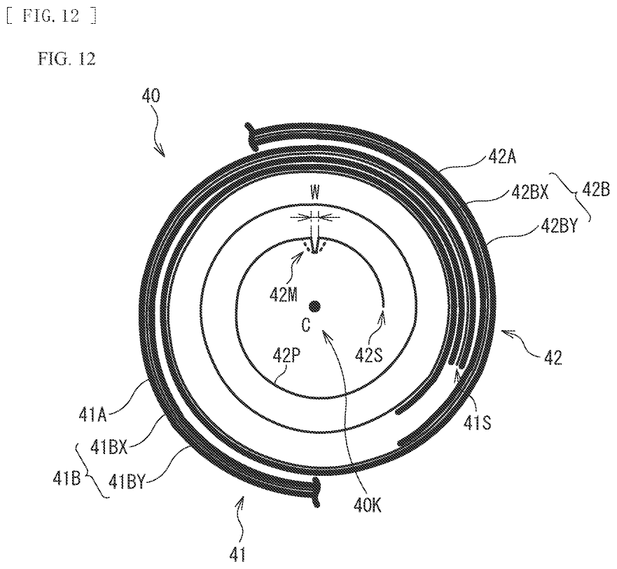

FIG. 9 illustrates a schematic configuration of a secondary battery of a comparative example, and corresponds to FIG. 4. FIG. 10 illustrates a schematic configuration corresponding to FIG. 8 to describe the process of fabricating the battery device 40 in the secondary battery of the comparative example. FIG. 11 illustrates a schematic configuration corresponding to FIG. 9 to describe an issue related to the secondary battery of the comparative example. FIG. 12 illustrates a schematic configuration corresponding to FIG. 4 to describe advantages of the secondary battery of the present embodiment.

The secondary battery of the comparative example has a configuration similar to the configuration of the secondary battery of the present embodiment illustrated in FIG. 4, except that the leading end part 42P includes no bent part 42M, as illustrated in FIG. 9. The secondary battery of the comparative example is manufactured in accordance with a procedure similar to the method of manufacturing the secondary battery of the present embodiment illustrated in FIG. 8, except that the battery device 40 is formed using a jig 160 instead of the jig 60, as illustrated in FIG. 10. The jig 160 has a configuration similar to the configuration of the jig 60 except that the jig 160 is without the recessed part 60N.

In the process of manufacturing the secondary battery of the comparative example, as illustrated in FIG. 10, the positive electrode 41 and the negative electrode 42 are each wound using the jig 160 without the recessed part 60N. As a result, no bent part 42M is formed in the leading end part 42P, as illustrated in FIG. 9.

In the secondary battery of the comparative example, if the battery device 40 expands upon charging, an internal stress causing each of the leading ends 41S and 42S to be shifted toward the inner circumference side is generated due to tendency of the positive electrode 41 and the negative electrode 42 to strongly tighten in the vicinity of the center C. The expansion of the battery device 40 occurs mainly due to expansion of the negative electrode active material included in the negative electrode active material layers 42B (the inner winding side layer 42BX and the outer winding side layer 42BY).

In this case, because the internal stress is not mitigated inside the battery device 40, as illustrated in FIG. 11, leading end portions of the positive electrode active material layers 41B (the inner winding side layer 41BX and the outer winding side layer 41BY) on the inner circumference side easily buckle toward the center C due to the internal stress. As a result, the leading end portions of the positive electrode active material layers 41B locally push the negative electrode 42 toward the center C, causing the negative electrode 42 to partly buckle toward the winding center space 40K easily. Note that due to the leading end portions of the positive electrode active material layers 41B locally pushing the negative electrode 42 toward the center C, a leading end portion of the leading end part 42P is bent toward the center C.

If the leading end portions of the positive electrode active material layers 41B break through the outer winding side layer 42BY upon buckling of the leading end portions, the positive electrode current collector 41A and the negative electrode current collector 42A come into contact with each other. A short circuit thus easily occurs in the battery device 40. Repetition of charging and discharging results in a marked tendency for a short circuit to occur in this way. In other words, even if no short circuit occurs upon initial charging, repeated charging and discharging will cause a short circuit to occur more easily.

For these reasons, in the secondary battery of the comparative example, a short circuit easily occurs upon charging and discharging, which makes it difficult to achieve superior operational reliability.

In contrast, in the secondary battery of the present embodiment, if an internal stress is generated due to expansion of the battery device 40 upon charging, the internal stress causes the leading end part 42P to be so deformed that the width W is narrowed in the bent part 42M, as illustrated in FIG. 12. In other words, in the bent part 42M, the leading end part 42P is so folded that respective portions of the leading end part 42P opposed to each other are brought closer to each other. In FIG. 12, the bent part 42M before deformation is indicated in a broken line.

In this case, the internal stress is mitigated because the leading end part 42P is so deformed, by virtue of the bent part 42M, as to substantially reduce a winding length of the negative electrode 42. The leading end portions of the positive electrode active material layers 41B are thereby prevented from easily buckling toward the center C, and as a result, the leading end portions of the positive electrode active material layers 41B simply shift slightly toward the center C in the winding direction. This makes it less easy for the leading end portions of the positive electrode active material layers 41B to locally push the negative electrode 42 toward the center C. The negative electrode 42 is thus prevented from easily buckling.

If the negative electrode 42 is prevented from easily buckling, the leading end portions of the positive electrode active material layers 41B are prevented from easily breaking through the outer winding side layer 42BY. This prevents a short circuit from easily occurring in the battery device 40. The tendency of a short circuit to be prevented from easily occurring remains the same even if charging and discharging is repeated.

Based upon the above, according to the secondary battery of the present embodiment, it is possible to achieve superior operational reliability because a short circuit is prevented from easily occurring upon charging and discharging. In this case, in particular, even in a small-sized secondary battery including the outer package can 10 of a columnar shape, the occurrence of a short circuit is sufficiently suppressed and therefore it is possible to achieve sufficient operational reliability.

According to the secondary battery of the present embodiment, in particular, in the leading end part 42P, the negative electrode current collector 42A may be exposed, without the negative electrode active material layers 42B (the inner winding side layer 42BX and the outer winding side layer 42BY) being provided on the negative electrode current collector 42A. This suppresses the occurrence of a short circuit while allowing for a high gravimetric energy density. Accordingly, it is possible to achieve higher effects.

Further, the angle θ that determines the position of the bent part 42M may be in the range from 15° to 345° both inclusive, and more preferably, in the range from 15° to 165° both inclusive or in the range from 195° to 345° both inclusive. In such a case, a short circuit is further prevented from easily occurring in the battery device 40. Accordingly, it is possible to achieve higher effects.

In this case, the leading end part 42P may include one bent part 42M, and the angle θ may be in the range from 75° to 105° both inclusive, or in the range from 255° to 285° both inclusive. In such a case, a short circuit is still further prevented from easily occurring in the battery device 40. Accordingly, it is possible to achieve still higher effects.

Further, the outer package can 10 having an electrical conducting property may have the through hole 10K, the external terminal 20 disposed on the outer side of the outer package can 10 may block the through hole 10K, and the gasket 30 having an insulating property may be disposed between the outer package can 10 and the external terminal 20. In such a case, the external terminal 20 serves as an external coupling terminal of the secondary battery. This makes it easier to couple the secondary battery to electronic equipment via the external terminal 20 serving as the external coupling terminal. Accordingly, it is possible to achieve higher effects.

In this case, the positive electrode 41 may be electrically coupled to the external terminal 20, and the negative electrode 42 may be electrically coupled to the outer package can 10. In such a case, the external terminal 20 serves as an external coupling terminal of the positive electrode 41, and the outer package can 10 serves as an external coupling terminal of the negative electrode 42. This makes it still easier to couple the secondary battery to electronic equipment via the outer package can 10 and the external terminal 20 serving as a pair of external coupling terminals. Accordingly, it is possible to achieve still higher effects. Further, an increase in volumetric energy density is achievable because it is unnecessary for the secondary battery to be provided with an external coupling terminal of the negative electrode 42 separate from the outer package can 10. Accordingly, it is possible to achieve still higher effects.

Further, the outer package can 10 may include the container part 11 and the cover part 12, and the container part 11 and the cover part 12 may be joined to each other. In such a case, the secondary battery is configured using the outer package can 10 that is a crimpless joined can. Accordingly, the volumetric energy density increases, which makes it possible to achieve higher effects.

In this case, the cover part 12 may include the recessed part 12U, and the external terminal 20 may be disposed inside the recessed part 12U. This makes the height H of the secondary battery smaller. Accordingly, the volumetric energy density increases further, which makes it possible to achieve higher effects.

Further, the height H1 may be smaller than the outer diameter D1 in the battery device

40. In such a case, the occurrence of a short circuit is sufficiently suppressed in the battery device 40 even in a small-sized secondary battery. Accordingly, it is possible to achieve higher effects.

Further, the secondary battery may include a lithium-ion secondary battery. In such a case, a sufficient battery capacity is stably obtainable through the use of insertion and extraction of lithium. Accordingly, it is possible to achieve higher effects.

The configuration of the secondary battery described above is appropriately modifiable, including as described below, according to an embodiment. Note that any two or more of the following series of modifications may be combined with each other according to an embodiment.

In each of FIGS. 4 and 5, the leading end part 42P includes one bent part 42M. However, the number of the bent parts 42M is not particularly limited as described above. The number of the bent parts 42M is therefore not limited to one, and may be two or more.

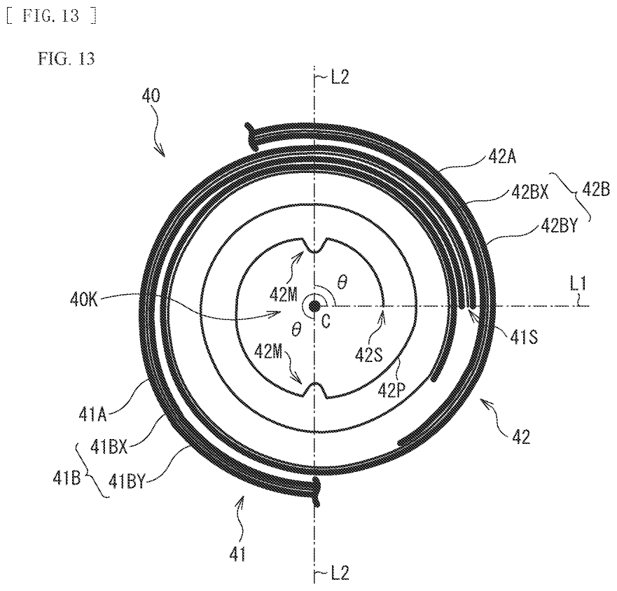

Specifically, as illustrated in FIG. 13 corresponding to FIGS. 4 and 5, the leading end part 42P may include two bent parts 42M. The angle θ that determines the position of a first one of the bent parts 42M is in the range from 75° to 105° both inclusive, and the angle θ that determines the position of a second one of the bent parts 42M is in the range from 255° to 285° both inclusive.

In this case also, the two bent parts 42M help to prevent a short circuit from easily occurring upon charging and discharging. Accordingly, it is possible to achieve similar effects. In this case, in particular, it becomes easier to mitigate the internal stress generated upon charging, as compared with when the leading end part 42P includes only one bent part 42M. It is thus possible to achieve higher effects. Further, the two angles θ determining the respective positions of the two bent parts 42M satisfy the preferable conditions described above (the range from 75° to 105° both inclusive and the range from 255° to 285° both inclusive). Accordingly, it is possible to achieve higher effects.

Needless to say, although not specifically illustrated here, the number of the bent parts 42M is not limited to one or two, and may be three or more, and the angles θ determining the respective positions of the bent parts 42M may be set to satisfy the preferable conditions described above or to satisfy any other conditions.

In each of FIGS. 4 and 5, the positive electrode 41 and the negative electrode 42 are so wound that the negative electrode 42 is disposed on the inner winding side relative to the positive electrode 41, and the leading end part 42P thus includes the bent part 42M.

However, although not specifically illustrated here, the positive electrode 41 serving as the first electrode and the negative electrode 42 serving as the second electrode may be so wound that the positive electrode 41 is disposed on the inner winding side relative to the negative electrode 42. The positive electrode 41 may include a leading end part corresponding to the leading end part 42P, and the leading end part may thus include the bent part. The leading end part may be, as described above, a portion in which no positive electrode active material layer 41B (neither the inner winding side layer 41BX nor the outer winding side layer 41BY) is provided on the positive electrode current collector 41A. Respective configurations of the positive electrode 41 and the negative electrode 42 in this case are similar to those in the case illustrated in FIGS. 4 and 5, except that the configuration of the positive electrode 41 and the configuration of the negative electrode 42 are interchanged.

In this case also, the bent part provided in the leading end part of the positive electrode 41 helps to prevent a short circuit from easily occurring. Accordingly, it is possible to achieve similar effects.

In FIG. 2, the cover part 12 includes the recessed part 12U, and the external terminal 20 is disposed inside the recessed part 12U.

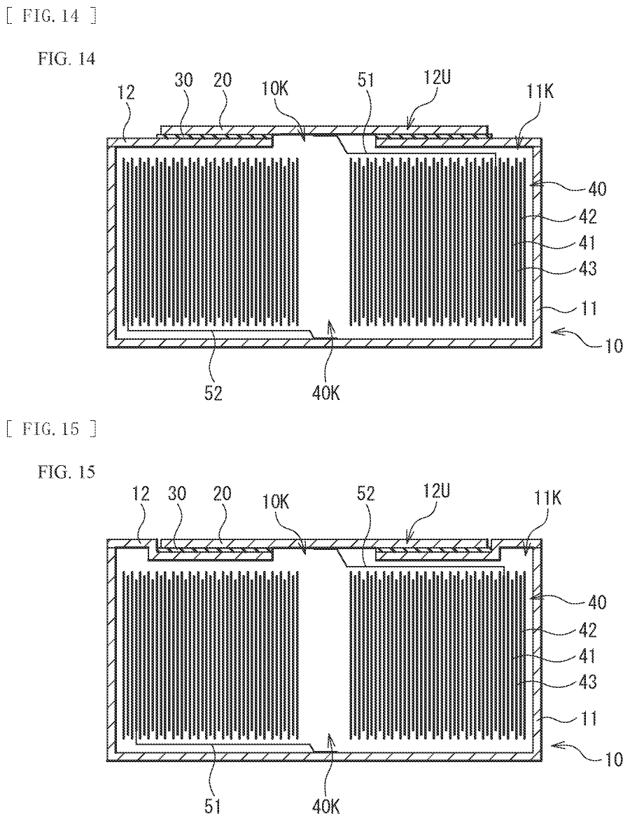

However, as illustrated in FIG. 14 corresponding to FIG. 2, the cover part 12 may include no recessed part 12U and thus be substantially flat, and the external terminal 20 may be disposed on the cover part 12. Even in this case, it is possible to achieve effects similar to the effects achievable in the case illustrated in FIG. 2. It should be noted, however, that an increase in the height H of the secondary battery can result in a decrease in volumetric energy density.

In FIG. 2, the positive electrode 41 serving as the second electrode is coupled to the external terminal 20 via the positive electrode lead 51, and the negative electrode 42 serving as the first electrode is coupled to the container part 11 via the negative electrode lead 52. Thus, the external terminal 20 serves as the external coupling terminal of the positive electrode 41, and the outer package can 10 serves as the external coupling terminal of the negative electrode 42.

However, as illustrated in FIG. 15 corresponding to FIG. 2, the positive electrode 41 serving as the first electrode may be coupled to the container part 11 via the positive electrode lead 51, and the negative electrode 42 serving as the second electrode may be coupled to the external terminal 20 via the negative electrode lead 52. Thus, the outer package can 10 may serve as the external coupling terminal of the positive electrode 41, and the external terminal 20 may serve as the external coupling terminal of the negative electrode 42.

In this case, to serve as the external coupling terminal of the negative electrode 42, the external terminal 20 includes any one or more of electrically conductive materials including a metal material and an alloy material. Specific examples of the electrically conductive materials include iron, copper, nickel, stainless steel, an iron alloy, a copper alloy, and a nickel alloy. To serve as the external coupling terminal of the positive electrode 41, the outer package can 10, that is, each of the container part 11 and the cover part 12 includes any one or more of electrically conductive materials including a metal material and an alloy material. Specific examples of the electrically conductive materials include aluminum, an aluminum alloy, and stainless steel.

In this case also, the secondary battery is couplable to electronic equipment via the external terminal 20 (the external coupling terminal of the negative electrode 42) and the outer package can 10 (the external coupling terminal of the positive electrode 41). Accordingly, it is possible to achieve effects similar to the effects achievable in the case illustrated in FIG. 2.

The separator 43 that is a porous film is used. However, although not specifically illustrated here, a separator of a stacked type may be used instead of the separator 43. The separator of the stacked type includes a polymer compound layer.

Specifically, the separator of the stacked type includes a porous film having two opposed surfaces, and the polymer compound layer provided on one of or each of the two opposed surfaces of the porous film. A reason for this is that adherence of the separator to each of the positive electrode 41 and the negative electrode 42 improves to allow for suppression of winding displacement of the battery device 40. Accordingly, the secondary battery is prevented from easily swelling even if a decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that the insulating particles dissipate heat upon heat generation of the secondary battery, thus improving safety or heat resistance of the secondary battery. The insulating particles are inorganic particles, resin particles, or both, for example. Specific examples of the inorganic particles include particles of: aluminum oxide, aluminum nitride, boehmite, silicon oxide, titanium oxide, magnesium oxide, and zirconium oxide. Specific examples of the resin particles include particles of acrylic resin and particles of styrene resin.

When fabricating the separator of the stacked type, a precursor solution including, without limitation, the polymer compound and a solvent is prepared, following which the precursor solution is applied on one of or each of the two opposed surfaces of the porous film. In this case, instead of applying the precursor solution on the porous film, the porous film may be immersed in the precursor solution. In addition, the insulating particles may be added to the precursor solution.

When the separator of the stacked type is used also, lithium ions are movable between the positive electrode 41 and the negative electrode 42, and similar effects are therefore achievable. In this case, in particular, the safety of the secondary battery improves as described above. Accordingly, it is possible to achieve higher effects.

The electrolytic solution that is a liquid electrolyte is used. However, although not specifically illustrated here, an electrolyte layer that is a gel electrolyte may be used instead of the electrolytic solution.

In the battery device 40 including the electrolyte layer, the positive electrode 41 and the negative electrode 42 are stacked on each other with the separator 43 and the electrolyte layer interposed between the positive electrode 41 and the negative electrode 42, and the stack of the positive electrode 41, the negative electrode 42, the separator 43, and the electrolyte layer is wound. The electrolyte layer is interposed between the positive electrode 41 and the separator 43, and between the negative electrode 42 and the separator 43. Note that the electrolyte layer may be interposed only between the positive electrode 41 and the separator 43, or may be interposed only between the negative electrode 42 and the separator 43.

Specifically, the electrolyte layer includes a polymer compound together with the electrolytic solution. The electrolytic solution is held by the polymer compound. A reason for this is that leakage of the electrolytic solution is prevented. The configuration of the electrolytic solution is as described above. The polymer compound includes, for example, polyvinylidene difluoride. When forming the electrolyte layer, a precursor solution including, for example, the electrolytic solution, the polymer compound, and a solvent is prepared, following which the precursor solution is applied on one of or each of both sides of the positive electrode 41 and on one of or each of both sides of the negative electrode 42.

When the electrolyte layer is used also, similar effects are achievable because lithium ions are movable between the positive electrode 41 and the negative electrode 42 through the electrolyte layer. In this case, it is possible to achieve higher effects because leakage of the electrolytic solution is prevented, in particular.

### EXAMPLES

Examples of the present technology are described below according to an embodiment.

### Examples 1 to 10 and Comparative Example 1

Secondary batteries were fabricated, and thereafter the fabricated secondary batteries were evaluated for their characteristics.

### [Fabrication of Secondary Battery]

Lithium-ion secondary batteries of the button type were fabricated in accordance with a procedure described below.

### (Fabrication of Positive Electrode)

First, 91 parts by mass of the positive electrode active material (LiCoO₂), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into a solvent (N-methyl-2-pyrrolidone as an organic solvent), following which the solvent was stirred to thereby prepare a positive electrode mixture slurry in paste form. Thereafter, the positive electrode mixture slurry was applied on the two opposed surfaces of the positive electrode current collector 41A (a band-shaped aluminum foil having a thickness of 15 μm) by means of a coating apparatus, following which the applied positive electrode mixture slurry was dried to thereby form the positive electrode active material layers 41B (the inner winding side layer 41BX and the outer winding side layer 41BY). Lastly, the positive electrode active material layers 41B were compression-molded by means of a roll pressing machine. The positive electrode 41 was thus fabricated.

### (Fabrication of Negative Electrode)

First, 95 parts by mass of the negative electrode active material (artificial graphite) and 5 parts by mass of the negative electrode binder (a styrene-butadiene rubber and carboxymethyl cellulose) were mixed with each other to thereby obtain a negative electrode mixture. Thereafter, the negative electrode mixture was put into a solvent (pure water, an aqueous solvent), following which the solvent was stirred to thereby prepare a negative electrode mixture slurry in paste form. Thereafter, the negative electrode mixture slurry was applied on the two opposed surfaces of the negative electrode current collector 42A (a band-shaped copper foil having a thickness of 10 μm) by means of a coating apparatus, following which the applied negative electrode mixture slurry was dried to thereby form the negative electrode active material layers 42B (the inner winding side layer 42BX and the outer winding side layer 42BY). In this case, the range of application of the negative electrode mixture slurry was adjusted to form the leading end part 42P. Lastly, the negative electrode active material layers 42B were compression-molded by means of a roll pressing machine. The negative electrode 42 was thus fabricated.

### (Preparation of Electrolytic Solution)

The electrolyte salt (LiPF₆) was added to the solvent, following which the solvent was stirred. A mixture of ethylene carbonate and propylene carbonate, each being the cyclic carbonic acid ester, was used as the solvent. In this case, a content of the electrolyte salt was set to 1 mol/kg with respect to the solvent. The electrolytic solution was thus prepared.

### (Assembly of Secondary Battery)

First, the positive electrode lead 51 (an aluminum foil) was welded to the positive electrode current collector 41A of the positive electrode 41 by means of a resistance welding method, and the negative electrode lead 52 (a nickel foil) was welded to the negative electrode current collector 42A of the negative electrode 42 by means of a resistance welding method.

Thereafter, the stacked body 40Z1 was formed by stacking the positive electrode 41 and the negative electrode 42 on each other with the separator 43 (a polyethylene film having a thickness of 9.5 μm) interposed between the positive electrode 41 and the negative electrode 42. Thereafter, by using the jig 60 having the recessed part 60N, the stacked body 40Z1 was wound around the jig 60, following which the jig 60 was removed to thereby form the wound body 40Z2 having the winding center space 40K. In this case, the negative electrode 42 was caused to be located on the inner winding side relative to the positive electrode 41, and the leading end 42S was caused to be located on the inner winding side relative to the leading end 41S. Further, the leading end part 42P was wound approximately twice, and the leading end 41S was caused to be located on the outer winding side relative to the leading end part 42P. The bent part 42M was thus formed in the leading end part 42P.

The number of the bent parts 42M and the positions of the bent parts 42M (the angles θ (°) determining the positions of the bent parts 42M) were as listed in Table 1. In this case, the number of the recessed parts 60N provided in the jig 60 was changed to thereby adjust the number of the bent parts 42M. Further, the positions of the recessed parts 60N provided in the jig 60 were changed to thereby adjust the positions of the bent parts 42M (the angles θ).

Thereafter, the wound body 40Z2 was placed into the container part 11 (SUS316) through the opening 11K. In this case, a welding electrode was placed into the winding center space 40K to thereby weld the negative electrode lead 52 to the container part 11 by means of a resistance welding method.

Thereafter, the electrolytic solution was injected into the container part 11 through the opening 11K, following which the cover part 12 (SUS316) was welded to the container part 11 by means of a laser welding method. To the cover part 12, the external terminal 20 (SUS316) had been thermally welded with the gasket 30 (polypropylene) interposed between the external terminal 20 and the cover part 12. In this case, the positive electrode lead 51 was welded to the external terminal 20 through the through hole 10K by means of a resistance welding method.

Thus, the battery device 40 was fabricated as a result of impregnation of the wound body 40Z2 (including the positive electrode 41, the negative electrode 42, and the separator 43) with the electrolytic solution, and the outer package can 10 was formed as a result of welding of the cover part 12 to the container part 11. The battery device 40 and other components were thus sealed in the outer package can 10. In this manner, the secondary battery was assembled.

For the purpose of comparison, a secondary battery was assembled in accordance with a similar procedure except that the stacked body 40Z1 was wound using the jig 160 without the recessed part 60N. In this case, no bent part 42M was formed in the leading end part 42P.

### (Stabilization of Secondary Battery)

The secondary battery after being assembled was charged and discharged for one cycle in an ambient temperature environment (at a temperature of 23° C.). Upon the charging, the secondary battery was charged with a constant current of 0.5 C until a voltage reached 4.4 V, and was thereafter charged with a constant voltage of 4.4 V until a current reached 0.05 C. Upon the discharging, the secondary battery was discharged with a constant current of 0.2 C until the voltage reached 3.0 V. Note that 0.5 C was a value of a current that caused the battery capacity (a theoretical capacity) to be completely discharged in 2 hours, 0.05 C was a value of a current that caused the battery capacity to be completely discharged in 20 hours, and 0.2 C was a value of a current that caused the battery capacity to be completely discharged in 5 hours.

As a result, a film was formed on the surface of each of the positive electrode 41 and the negative electrode 42, which brought the secondary battery into an electrochemically stable state. The secondary battery was thus completed.

### [Characteristic Evaluation of Secondary Battery]

Evaluation of the secondary batteries for their characteristics (operational reliability) revealed the results presented in Table 1.

When evaluating the operational reliability, the secondary battery (the wound state of the positive electrode 41 and the negative electrode 42) was first observed by X-ray radiography to thereby identify the position (the position before charging and discharging) of the leading end 41S of the positive electrode 41.

Thereafter, the secondary battery was charged and discharged for 500 cycles in an ambient temperature environment (at a temperature of 23° C.). Charging and discharging conditions were similar to the charging and discharging conditions for the stabilization of the secondary battery described above.

Thereafter, the secondary battery was observed again by X-ray radiography to thereby identify the position (the position after the charging and discharging) of the leading end 41S. Lastly, a buckling distance Q (μm) as an index for evaluating the operational reliability was measured based on the position of the leading end 41S before the charging and discharging and the position of the leading end 41S after the charging and discharging. As illustrated in FIG. 11, the buckling distance Q is a distance between the position of the leading end 41S before the charging and discharging and the position of the leading end 41S after the charging and discharging. In FIG. 11, the leading end portion of the positive electrode 41 before the charging and discharging is indicated in a broken line.

When measuring the buckling distance Q, the above-described evaluation procedure was repeated using ten secondary batteries to thereby measure ten buckling distances Q. Based on the results, as listed in Table 1, the ten buckling distances Q were classified, in accordance with their values, into four ranges (Q≤50 μm; 50 μm<Q≤100 μm; 100 μm<Q≤200 μm; and Q>200 μm).

Note that the greater the buckling distance Q, the easier it is for the negative electrode 42 to buckle greatly. Thus, a greater buckling distance Q indicates that a short circuit occurs easily. In contrast, the smaller the buckling distance Q, the less easy it is for the negative electrode 42 to buckle greatly. Thus, a smaller buckling distance Q indicates that a short circuit occurs less easily.

TABLE 1

| | Bent part | | | | | |
|---|---|---|---|---|---|---|
| | | Angle θ | Buckling distance Q | | | |
| | Number | (°) | Q > 200 μm | 100 μm < Q ≤ 200 μm | 50 μm < Q ≤ 100 μm | Q ≤ 50 μm |
| Example 1 | 1 | 0 | 7/10 | 2/10 | 1/10 | 0/10 |
| Example 2 | 1 | 45 | 3/10 | 5/10 | 2/10 | 0/10 |
| Example 3 | 1 | 90 | 0/10 | 1/10 | 3/10 | 6/10 |
| Example 4 | 1 | 135 | 1/10 | 4/10 | 3/10 | 2/10 |
| Example 5 | 1 | 180 | 5/10 | 3/10 | 2/10 | 0/10 |
| Example 6 | 1 | 225 | 1/10 | 5/10 | 2/10 | 2/10 |
| Example 7 | 1 | 270 | 0/10 | 1/10 | 3/10 | 6/10 |
| Example 8 | 1 | 315 | 3/10 | 4/10 | 3/10 | 0/10 |
| Example 9 | 2 | 90, 270 | 0/10 | 0/10 | 0/10 | 10/10 |
| Example 10 | 3 | 60, 180, 300 | 0/10 | 1/10 | 2/10 | 7/10 |
| Comparative | — | — | 10/10 | 0/10 | 0/10 | 0/10 |
| example 1 | | | | | | |

As indicated in Table 1, the buckling distance Q varied depending on the presence or absence of the bent part 42M and the configuration of the bent part 42M, that is, the number of the bent parts 42M and the angle(s) θ.

Specifically, when no bent part 42M was provided in the leading end part 42P (Comparative example 1), the buckling distance Q was large. Specifically, the buckling distance Q exceeded 200 μm in all the secondary batteries.

In contrast, when one or more bent parts 42M were provided in the leading end part 42P (Examples 1 to 10), the buckling distance Q was smaller than in the above-described case where no bent part 42M was provided in the leading end part 42P (Comparative example 1). Specifically, the buckling distance Q exceeded 200 μm in only some of the secondary batteries.

In particular, when one or more bent parts 42M were provided in the leading end part 42P, the following tendencies were observed. Firstly, when the angle θ was 90° (i.e., in the range from 15° to 165° both inclusive, more specifically, in the range from 75° to 105° both inclusive) or 270° (i.e., in the range from 195° to 345° both inclusive, more specifically, in the range from 255° to 285° both inclusive) (Examples 3 and 7), the buckling distance Q was 200 μm or less in all the secondary batteries. Secondly, when the number of the bent parts 42M was two or more (Examples 9 and 10), the buckling distance Q further decreased. Thirdly, when the number of the bent parts 42M was two or more and the angles θ were 90° and 270° (Example 9), the buckling distance Q markedly decreased.

The results presented in Table 1 indicate that when the leading end part 42P of the negative electrode 42 included the bent part(s) 42M, the buckling distance Q decreased, which indicates that it became less easy for the negative electrode 42 to buckle. Accordingly, it became less easy for a short circuit to occur upon charging and discharging. The secondary battery thus achieved superior operational reliability.

Although the present technology has been described above according to one or more embodiments including Examples, the configuration of the present technology is not limited thereto, and is therefore modifiable in a variety of suitable ways.

For example, although the description has been given of the case where the electrode reactant is lithium, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited thereto. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an outer package member having a columnar shape; and
a battery device contained inside the outer package member and including a first electrode and a second electrode, wherein
the first electrode and the second electrode are opposed to each other and wound,
the first electrode includes a leading end part located on a side close to a center of the battery device,
the leading end part is wound once or more on a side closer to the center of the battery device than the second electrode, and includes one or more bent parts, and
in the one or more bent parts, the leading end part is bent to be partly recessed toward the center of the battery device.

2. The secondary battery according to claim 1, wherein
the first electrode includes a current collector, and an active material layer provided on the current collector, and
in the leading end part, the current collector is exposed, without the active material layer being provided on the current collector.

3. The secondary battery according to claim 1, wherein an angle defined by a first straight line and a second straight line is greater than or equal to 15 degrees and less than or equal to 345 degrees, the first straight line coupling the center of the battery device and a leading end of the second electrode located on the side close to the center of the battery device to each other, the second straight line coupling the center of the battery device and a center of each of the one or more bent parts to each other.

4. The secondary battery according to claim 3, wherein the angle is greater than or equal to 15 degrees and less than or equal to 165 degrees, or is greater than or equal to 195 degrees and less than or equal to 345 degrees.

5. The secondary battery according to claim 3, wherein
the one or more bent parts of the leading end part comprise one bent part, and
the angle is greater than or equal to 75 degrees and less than or equal to 105 degrees, or is greater than or equal to 255 degrees and less than or equal to 285 degrees.

6. The secondary battery according to claim 3, wherein
the one or more bent parts of the leading end part comprise two bent parts, and
the angle for a first one of the one or more bent parts is greater than or equal to 75 degrees and less than or equal to 105 degrees, and
the angle for a second one of the one or more bent parts is greater than or equal to 255 degrees and less than or equal to 285 degrees.

7. The secondary battery according to claim 1, wherein
the outer package member has a through hole, and
the secondary battery further comprises:
an electrode terminal disposed on an outer side of the outer package member and blocking the through hole; and
an insulating sealing member disposed between the outer package member and the electrode terminal.

8. The secondary battery according to claim 7, wherein
the outer package member has an electrical conducting property,
one of the first electrode or the second electrode is electrically coupled to the electrode terminal, and
another of the first electrode or the second electrode is electrically coupled to the outer package member.

9. The secondary battery according to claim 7, wherein
the outer package member includes:
a container part having an opening and containing the battery device inside; and
a cover part having the through hole and closing the opening, and
the container part and the cover part are joined to each other.

10. The secondary battery according to claim 9, wherein
the cover part includes a recessed part in which the through hole is provided,
in the recessed part, the cover part is bent to be partly recessed toward an inside of the container part, and
the electrode terminal is disposed inside the recessed part.

11. The secondary battery according to claim 1, wherein
the battery device has a columnar shape and includes two bottom parts opposed to each other, and
a height of the battery device is smaller than an outer diameter of the battery device, the height of the battery device being a distance between the two bottom parts.

12. The secondary battery according to claim 1, wherein the secondary battery comprises a lithium-ion secondary battery.
